(19) United States
(12) Patent Application Publication
(10) Pub. No.: US 2005/0209745 A1
(43) Pub. Date: Sep. 22, 2005

(54) Method and apparatus for taking over an aircraft in case of an emergency

(76) Inventor: Manfred Watzl, Neuendettelsau (DE)

Correspondence Address: HENRY M FEIEREISEN, LLC, 350 FIFTH AVENUE, SUITE 4714, NEW YORK, NY, 10118, US

(21) Appl. No.: 10/801,408

(22) Filed: Mar. 16, 2004

(51) Int. Cl. G06F 17/00

(52) U.S. Cl. 701/9; 701/11

(57) ABSTRACT

A method of protecting an airborne aircraft against hijacking, involves activating an autopilot system for automatically flying an aircraft to a landing at a nearest airport in communication with the autopilot system; and immobilizing all persons on-board on the aircraft.

### BACKGROUND OF THE INVENTION

The present invention relates, in general, to an anti-hijacking system, and more particularly to a system for taking over an aircraft and piloting the aircraft to a safe landing in case of an emergency.

Aircraft hijacking has been a problem for many years and oftentimes results in catastrophic outcomes. In order to respond to this threat, proposals have been advanced that empower a pilot in the cockpit to release a gas while the aircraft is in flight to thereby immobilize the passengers. Examples of such an approach are disclosed in German patent publication nos. DE-OS 2 255 037 and DE-OS 2 047 109. Other approaches, as disclosed, for example, in German patent publication nos. DE 100 00 696 A1 or DE 195 04 084 A1, involve the release of an anesthetic into the entire interior space of an aircraft that is still on ground.

It would be desirable and advantageous to provide an improved anti-hijacking system to obviate prior art shortcomings and to allow a safe and efficient take-over of an airborne aircraft while preventing a hijacker to wreak havoc.

### SUMMARY OF THE INVENTION

According to one aspect of the present invention, a method of preventing hijacking of an aircraft includes the steps of activating an autopilot system for automatically flying an aircraft to a landing at a nearest airport in communication with the autopilot system, and immobilizing all persons on-board the aircraft.

According to another feature of the present invention the immobilizing step includes the step of releasing a gas throughout the interior of the aircraft. As an alternative, it is also conceivable to incapacitate all persons by exposing the persons to acoustic irradiation or to electro-stimulation.

According to another aspect of the present invention, an apparatus for preventing hijacking of an aircraft includes a mechanism for activating an autopilot system for automatically flying an aircraft to a landing at a nearest airport in communication with the autopilot system, and a mechanism for immobilizing all persons on-board the aircraft.

The present invention resolves prior art problems by activating the autopilot system during flight and incapacitating all persons on board including pilots and flight attendants by releasing a gas, for example an anesthetic such as nitrous oxide (laughing gas), or exposure to acoustic irradiation or electro-stimulation. In this way, any hijacker on-board the aircraft will be incapacitated while the aircraft can still fly safely and be piloted to a safe landing to the nearest airport. As all persons on board are immobilized, the aircraft can fly without interference by the pilots or hijackers to the airport.

An anti-hijacking system according to the present invention can easily be installed in existing aircrafts by integrating suitable tubes, normally made of plastic, in the aircraft body for conducting the gas and release it throughout the interior via respective nozzles. The amount and the administered doses can hereby be selected in dependence on the size of the interior space and volatility of the gas so as to assure that all persons are immobilized. Suitably, the tubes are supplied from a gas pressure bottle via a manifold that leads to the tubes.

### BRIEF DESCRIPTION OF THE DRAWING

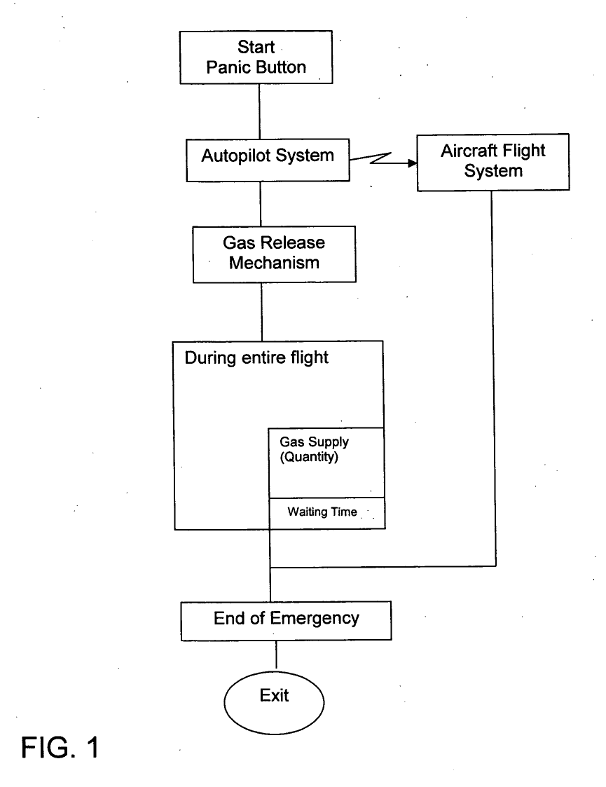

Other features and advantages of the present invention will be more readily apparent upon reading the following description of currently preferred exemplified embodiments of the invention with reference to the accompanying drawing, in which FIG. 1 is a block diagram of a process sequence according to the present invention.

### DETAILED DESCRIPTION OF PREFERRED EMBODIMENTS

The depicted embodiment is to be understood as illustrative of the invention and not as limiting in any way. It should also be understood that the drawings are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

Turning now to FIG. 1, there is shown a block diagram of a process sequence of an anti-hijacking system according to the present invention. Once the aircraft is airborne and an emergency situation arises as a result of a threat of a hijacking, the pilot activates the autopilot system to override any manual control of the aircraft so as to force the aircraft to land at the nearest airport. Once the autopilot system is activated, the on-board computer assumes control of the aircraft. At the same time, a gas is released into the interior space to incapacitate everyone on board, i.e. pilots, attendants, passengers and hijackers. Release of gas is continued so long as the aircraft is airborne. Hereby, the necessary amount of released quantities of gas can be determined beforehand and is dependent on the size of the affected interior space in the aircraft and the volatility of the gas being used. Once the aircraft has landed safely, ground personnel or other anti-terrorist personnel is able to board the aircraft, without jeopardizing the life of anybody. There is no need to use firearms or explosives as the hijackers have been neutralized beforehand.

The emergency circuit of the anti-hijacking system may be operated by a separate pre-programmed processor, in the event reserves of the on-board computer cannot be utilized. Structure and operation of an autopilot system to fly an aircraft to the nearest airport in communication with the autopilot system are generally known by the artisan so that a detailed description thereof is omitted for the sake of simplicity. A specific construction of an autopilot system that can be used in the anti-hijacking system of the present invention is fully described in U.S. Pat. publication No. 6,641,087 to Nelson. Maneuvering the aircraft to the nearest target airport can be realized through radio relay system and/or existing functions for automatic landing.

Equipping an aircraft with an anti-hijacking system according to the present invention can be realized as follows: A tube for compressed air is routed throughout the interior space of the aircraft and connected via a manifold to a gas pressure bottle. If necessary, a compressor may be disposed for compressing the gas. The cockpit can be provided with a panic button in the form of a toggle switch for actuation by a pilot. As alternative, speech recognition may also be used for activation of the anti-hijacking system, or the use of a touch screen may be conceivable. In general, the anti-hijacking system should be constructed as simple as possible to minimize any disturbances. The release of gas can be realized in intervals and, if necessary, effected with the aid of a compressor. An example of a gas used for the anti-hijacking may be any suitable anesthetic, e.g., nitrous oxide.

Structure and operation of a gas release mechanism for discharging gas into the interior space of the aircraft are generally known by the artisan so that a detailed description thereof is omitted for the sake of simplicity. A specific construction of an autopilot system that can be used in the anti-hijacking system of the present invention is fully described, e.g., in German pat. publication no. DE-OS 2 255 037.

While it is currently preferred to configure the anti-hijacking system according to the present invention in way that a pilot triggers the autopilot and the release of gas, it is certainly within the scope of the invention to have ground personnel activate the anti-hijacking system by remote control.

The anti-hijacking apparatus according to the present invention incapacitates hijackers and thus inhibits a control of the aircraft by terrorists. The use of firearms is eliminated during flight as well as after landing as all persons remain immobilized and incapacitated. Costs for retrofitting of existing aircrafts is insignificant as is the added weight component.

While the invention has been illustrated and described in connection with currently preferred embodiments shown and described in detail, it is not intended to be limited to the details shown since various modifications and structural changes may be made without departing in any way from the spirit of the present invention. The embodiments were chosen and described in order to best explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

1. A method of protecting an airborne aircraft against hijacking, comprising the steps of activating an autopilot system for automatically flying an aircraft to a landing at a nearest airport in communication with the autopilot system; and immobilizing all persons on-board on the aircraft.

2. The method of claim 1, wherein the immobilizing step includes the step of releasing a gas throughout the interior of the aircraft.

3. The method of claim 2, wherein the gas is nitrous oxide.

4. The method of claim 1, wherein the immobilizing step includes the step of exposing the persons to acoustic irradiation.

5. The method of claim 1, wherein the immobilizing step includes the step of exposing the persons to electro-stimulation.

6. Apparatus for protecting an airborne aircraft against hijacking, comprising:
first means for activating an autopilot system for automatically flying an aircraft to a landing at a nearest airport in communication with the autopilot system; and
second means for immobilizing all persons on-board on the aircraft.

7. The apparatus of claim 6, wherein the second means includes a release mechanism installed in a body of the aircraft for discharging a gas throughout the interior of the aircraft.

8. The apparatus of claim 7, wherein the gas is nitrous oxide.

9. The apparatus of claim 7, wherein the first means includes a manually operated panic button operatively connected to the autopilot system and the release mechanism.

10. The apparatus of claim 7, wherein the first means includes a panic button which is operatively connected to the autopilot system and the release mechanism and constructed for actuation through speech recognition.

11. The apparatus of claim 7, wherein the first means includes a panic button which is operatively connected to the autopilot system and the release mechanism and constructed for actuation by a touch screen.
